(19) United States
(12) Patent Application Publication
(10) Pub. No.: US 2009/0165145 A1
(43) Pub. Date: Jun. 25, 2009

(54) CHANGING MODES IN A DEVICE

(75) Inventors: Joonas-Petteri Haapsaari, Tampere (FI); Arto Olavi Makkonen, Tampere (FI); Antonio Guadagno, Tampere (FI); Mari Vuokko Rinta-Piirto, Lempaala (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/962,548

(22) Filed: Dec. 21, 2007

(51) Int. Cl. G06F 21/00

(52) U.S. Cl. 726/28

(57) ABSTRACT

A method including storing one or more user profile modes in a device, activating a user profile from the stored profiles where activating a user profile mode comprises configuring a user interface of the device to allow access to only applications and/or information associated with the activated user profile mode and displaying only applications and/or information associated with the activated user profile mode.

### BACKGROUND

1. Field

The disclosed embodiments generally relate to user interfaces and, more particularly, to changing a profile mode of a mobile communication device.

2. Brief Description of Related Developments

Users of mobile communication devices use their communication devices during work and/or during their free time (e.g. at home, on vacation, etc.). When at work the productivity of the user may not be maximized because the user interface of the mobile communication device can include non-work related data. Likewise when the user is enjoying his or her free time, maximum enjoyment of that free time may not be experienced because the user interface of the device includes work related data. Generally conventional mobile communication devices allow users to set or customize different profiles in the device. However, these different profiles generally do not provide separation between, for example, work related activities and non-work related activities.

While conventional mobile communication devices allow a user to change profiles of the device they generally do not allow a user to change the information presented or applications accessed by the device. Some conventional communication devices allow a user to switch between default or home screens (e.g. screens that provide general information user as well as a starting point for using the device) but when the home screen is switched generally only the background shown on a display of the device is changed.

It would be advantageous to allow a user to switch between different profile modes that are tailored to the user's lifestyle to provide a balance between the user's activities.

### SUMMARY

In one aspect, the disclosed embodiments are directed to a method. In one embodiment the method includes storing one or more user profile modes in a device, activating a user profile from the stored profiles where activating a user profile mode comprises configuring a user interface of the device to allow access to only applications and/or information associated with the activated user profile mode and displaying only applications and/or information associated with the activated user profile mode.

In another aspect, the disclosed embodiments are directed to an apparatus. In one embodiment the apparatus includes a processor, a display connected to the processor and a memory connected to the processor, wherein the processor is configured to store one or more user profile modes in the memory, activate a user profile from the stored profiles where when activating the user profile mode the processor is further configured to configure a user interface of the apparatus to allow access to only applications and/or information associated with the activated user profile mode and display only applications and/or information associated with the activated user profile mode.

In still another aspect, the disclosed embodiments are directed to a system. In one embodiment the system includes a communication device including a display, a memory and a processor connected to the display and memory, the processor being configured to store one or more user profile modes in the memory, activate a user profile from the stored profiles where when activating the user profile mode the processor is further configured to configure a user interface of the device to allow access to only applications and/or information associated with the activated user profile mode and display only applications and/or information associated with the activated user profile mode.

In another aspect, the disclosed embodiments are directed to a user interface. The user interface includes an input device, a display and a processor connected to the input and display, the processor being configured to store one or more user profile modes in the memory, activate a user profile from the stored profiles where when activating the user profile mode the processor is further configured to configure a user interface of the device to allow access to only applications and/or information associated with the activated user profile mode and display only applications and/or information associated with the activated user profile mode.

In another aspect, the disclosed embodiments are directed to an apparatus. The apparatus including means for storing one or more user profile modes in a device and means for activating a user profile from the stored profiles where activating a user profile mode includes configuring a user interface of the device to allow access to only applications and/or information associated with the activated user profile mode and displaying only applications and/or information associated with the activated user profile mode.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates a flow diagram of a process in accordance with an aspect of the disclosed embodiments;

FIGS. 3 and 4 are illustrations of exemplary screen shots of a user interface in accordance with the disclosed embodiments;

FIGS. 5A and 5B are illustrations of examples of devices that can be used to practice aspects of the disclosed embodiments;

FIG. 6 illustrates a block diagram of an exemplary system incorporating features that may be used to practice aspects of the disclosed embodiments; and

FIG. 7 is a block diagram illustrating the general architecture of an exemplary system in which the exemplary devices of FIGS. 5A and 5B may be used.

### DETAILED DESCRIPTION OF THE EMBODIMENT(S)

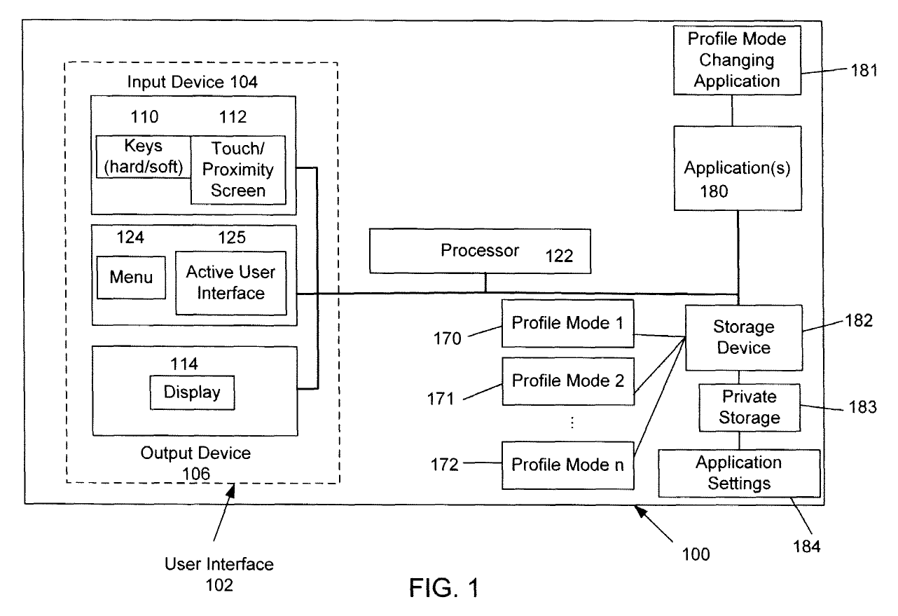

FIG. 1 illustrates one embodiment of a device 100 in which aspects of the disclosed embodiments can be applied. Although aspects of the disclosed embodiments will be described with reference to the embodiments shown in the drawings and described below, it should be understood that these aspects could be embodied in many alternate forms. In addition, any suitable size, shape or type of elements or materials could be used.

The disclosed embodiments generally allow a user of a device or system, such as the device 100 shown in FIG. 1 to switch or change between different modes or profiles. Changing between the different modes allows a user to tailor the device 100 to a user's lifestyle and provide a balance between the user's different activities. The disclosed embodiments include one or more options for changing a mode or profile of the device 100 so that operation of the device 100 coincides with any suitable activity the user is engaged. For example, the user may set up or create in the device 100 any suitable number modes or profiles 170-172 including, but not limited to, a work profile, a home profile, and a vacation profile.

The mode switches affect the look and feel of the device 100, the sounds produced by the device 100, the information shown on a display of the device 100 and the behavior of the applications 180 built in, installed or downloaded to the device 100. A user of the device 100 can configure each of the profiles 170-172 independently of each other. Each of the user interface elements within each profile 170-172 can also be independently configured by a user of the device 100.

Each of the different profiles can be configured to change the operation of the device 100 in any suitable manner including, but not limited to, limiting or granting access to data and/or applications stored in or accessible by the device 100, by changing settings of the device 100 and changing an appearance of the user interface. The profiles 170-172 can be configured so that information presented on a display 114 of the device relates only to active profile. The profiles 170-172 can also be configured to provide any suitable levels of access to information and/or applications. For example, non-work related profiles in the device 100 can be configured to protect work related applications and/or information such that when the device is in a non-work related profile a user is not able to access or is provided with limited or selective access to work related items.

In addition to providing security for data and device applications, the different profiles 170-172 can also track and/or limit the usage of the device. For example, communications made with the device 100 in one mode can be marked with an identifier while communications made while in another mode are marked with a different identifier. Identifying the communications allows the usage to be broken up into different categories for any suitable purpose including, but not limited to billing the user. In another example, any suitable communication features and/or services of the device 100 can also be controlled by the profiles 170-172. For example, while in a work profile the device 100 will only access certain communication access points and/or allow communication with only work related contacts.

In one aspect the device includes a menu system 124 that can provide for the selection of different tools and application options related to the applications or programs running on the device 100. In one embodiment, the menu system 124 may provide for the selection of applications or features associated with the profile modes 170-172 such as, for example, any suitable setting features including, but not limited to, the settable features described herein. For example, the menu system 124 can be configured to allow a user to configure each of the changeable profiles 170-172. In one example, the profiles 170-172 can be configured to include any suitable information and can be configured to separate, for example, work related contacts, data and functions from non-work related contacts, data and functions and vice versa. In other examples, any suitable functions and/or information of the system can be separated through the profiles 170-172. For example, the device 100 can be switched from a first or work profile 170 to a second profile 171 as the user is leaving a place of business. In one example, the device can be configured so work-related information or data is hidden and/or cannot be received by the device 100 when the second user interface 171 is active. In other embodiments, the work related data may be accessible within the second profile 171 through the use of security features as described herein. The data received by the system can include, but is not limited to, voice calls, voice messages, text messages, email and any other suitable data. The data presented by the system 100 can include, but is not limited to, calendar entries, phone books, to-do list items, email items, messaging items, voice mail items, clocks and any other suitable items, functions and/or links to items and/or functions of the system as will be described below.

Any suitable number of profiles 170-172 can be added or created in the device 100 and optimized for any suitable activities including, but not limited to work and non-work related activities. Examples of non-work related activities including, but not limited to, fishing, hunting, running, shopping, bicycling or any other suitable activities. Each profile 170-172 can be configured to present to the user the most important information and most relevant applications corresponding to a respective activity. As a non-limiting example, a hunting profile can include weather forecasts, times for sunrise and sunset, maps, a compass, and any other suitable information. Likewise, as another non-limiting example, a running profile can include a stopwatch, weather forecasts, and music players.

In one embodiment, still referring to FIG. 1, the device 100 can include an input device 104, output device 106, processor 122, applications area 180, and one or more storage/memory devices 182, 183. In the embodiments disclosed herein, the processor 122 receives certain inputs, such as for example, signals, transmissions, instructions or commands related to the functions of the device 100, such as information to be presented in the different profiles 170-172. Depending on the inputs, the processor 122 interprets the commands and executes the commands accordingly. The components described herein are merely exemplary and are not intended to encompass all components that can be included in the device 100. For example, in one embodiment the applications of the device may include, but are not limited to, data acquisition (e.g. image, video and sound), data processors (spread sheets, word processor, contact lists, currency converters, etc.) and multimedia players (e.g. video and music players). Thus, in alternate embodiments, the device 100 can include other suitable devices and applications for monitoring application content and acquiring data and providing communication capabilities in such a device. While the input device 104 and output device 106 are shown as separate devices, in one embodiment, the input device 104 and output device 106 can be combined and be part of, and form, the user interface 102.

In one embodiment, the user interface 102 of the disclosed embodiments can be implemented on or in a device that includes a touch screen display or a proximity screen device 112. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function. For example, the term “touch” in the context of a proximity screen device, does not necessarily require direct contact, but can include near or close contact, that activates the proximity device.

Similarly, the scope of the intended devices is not limited to single touch or contact devices. Multi-touch devices, where contact by one or more fingers or other pointing devices can navigate on and about the screen are also intended to be encompassed by the disclosed embodiments. Non-touch devices are also intended to be encompassed by the disclosed embodiments. Non-touch devices include, but are not limited to, brain computer interface (BCI) and devices without touch or proximity screens. In one embodiment, with non-touch devices such as BCI a user may use thoughts to control the devices described herein (i.e. through neuro-physiological signals detected from the brain or from other suitable nervous tissue). In another embodiment where navigation on the display with devices without touch or proximity screen is performed through, for example, keys 110 of the system or through voice commands via voice recognition features of the system.

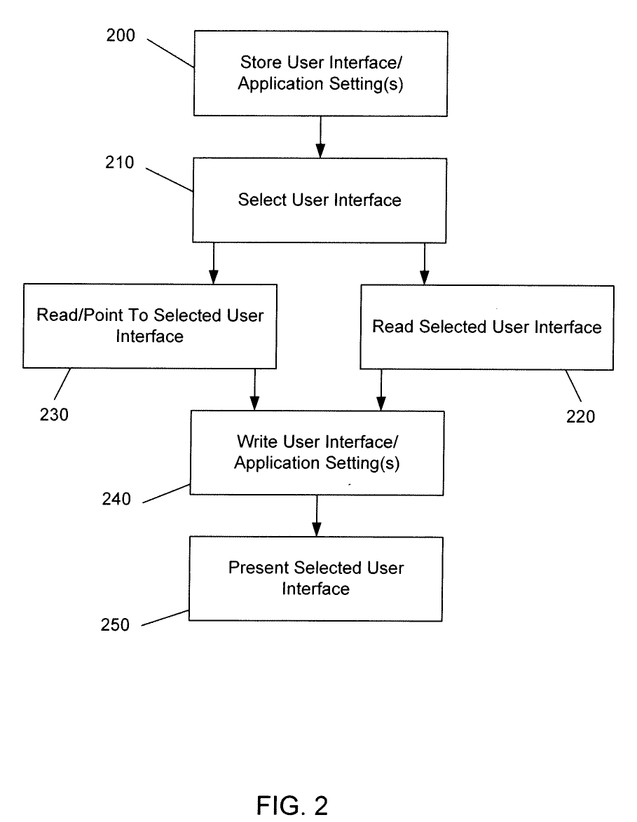

Referring also to FIG. 2, a flow chart illustrating one example of a process according to the disclosed embodiments is shown. It is noted that the profiles 170-172 may be switched from a default mode that may be installed in the device 100 during manufacture to a user defined profile. In other embodiments the profiles or modes may be switched between the user defined profiles such as modes 170-172. Switching profiles will affect application settings 184. The application settings 184 for each profile 170-172 can be stored in a private storage 183 so that the application settings 184 are accessible only by the profile/mode changing application 181 (FIG. 2, Block 200). In other embodiments the application settings 184 can be stored in any suitable storage and may be accessible by applications 180 other than the profile/mode changing application 181 described herein. For exemplary purposes only, the process shown in FIG. 2 will be described with respect to only two profiles or modes, but it should be understood that the process can be applied to any suitable number of profiles.

In one embodiment, a profile 170-172 that is to be activated is selected (FIG. 2, Block 210). The active profile can be selected in any suitable manner. For example, the active profile can be manually selected by a user of the device 100 or the device 100 can be configured to select the profile automatically. In one embodiment, the device 100 includes, for example, hard or soft keys 110, voice recognition features, or touch activated screens 112 configured to allow a user to select the active profile. In another embodiment the device 100 may be configured to select the active profile automatically. For example, the device 100 can be configured to select a profile 170-172 based on a time of day or schedule, a geographical location, when the device 100 passes by a suitable transmitter that interacts with a sensor of the device 100 (e.g. based on proximity devices, such as when a user passes through a doorway at his or her place of employment or at home). In other embodiments, the profiles 170-172 can be automatically changed based on any suitable temporal or spatial criteria. In this example the active profile of the device 100 is being switched from a first profile 170 to a second profile 171.

In one embodiment, the device 100 can be configured to prompt the user when the profile 170-172 is automatically switched. The prompt can allow the user to verify that the profile switch is to occur and gives the As a non-limiting example, if the device 100 is offline or in a silent mode (e.g. no audible alerts are presented to the user), the profile will not automatically change, but the device 100 will prompt the user for approval of the profile change. It is noted that in other examples, the profile may automatically change regardless of whether the system 100 is offline or in a silent mode.

After the second profile 171 is selected in one of the manners described above the profile settings/configuration is read from any suitable storage such as, for example, private storage (FIG. 2, Block 220). In other embodiments the profile settings/configuration can be read from storage 182 or a combination of storage 182 and private storage 183. When the active profile is switched from the first profile 170 to the second profile 171, the application settings 184 (which may include their respective user interface configurations) can be read from, for example, the private storage 183 (FIG. 2, Block 230) and written to their respective applications 180 and the device 100 (FIG. 2, Block 240) so that the application/system settings 184 for the second profile 171 can take effect immediately. In another embodiment, the device 100 and/or the applications 180 are pointed to a storage such as, for example, storage 182, 183 or a remote storage for the settings of the second profile 171. In still another embodiment, the profile settings can include links or pointers that are directed to the applications and/or information associated with the settings. It is noted that the settings/configuration for the first and second profiles 170, 171 may be located in the same storage, in different storages or any combination thereof. The device 100 can present at least visual information of the second profile 171 as the active user interface 125 (FIG. 2, Block 250) to the user at any suitable time such as before, after or while the application settings 184 are written to the applications 180.

In one embodiment, there may be a complete list of application settings 184 for each of the profiles 170-172. In other embodiments the application settings 184 can include one set of general use settings, which may be common to all of the profiles 170-172, and one set of specific settings for each of the profiles 170-172 so that only the elements of the specific settings that differ from the general settings are changed when the profiles 170-172 are switched. In another embodiment, the application settings 184 can include a single complete set of application settings for a default profile and separate settings for each additional profile so that only the settings that differ from the default profile settings are changed when switching profiles. In still other embodiments, any suitable combination of specific, general or default application settings may be stored in the device 100 to allow for switching between the profiles 170-172 as described herein.

In one embodiment, switching between the different profiles 170-172 can change any suitable functions and/or features of the applications 180 and/or device 100. For example, a graphical user interface or home screen, device theme, alerts profile (e.g. alert mode, silent mode, vibratory mode, offline mode), data (e.g. contacts, calendar items, etc.), browser, memory card settings, voice over IP settings, connectivity settings, hardware shortcut keys, email, call settings, user group settings, voice mail settings, call features, speed dial features, application menus, application access, text input features, playlists, really simple syndication (RSS) feeds, keypad graphics and lights and/or any other suitable settings of the device 100 may change when profiles 170-172 are switched.

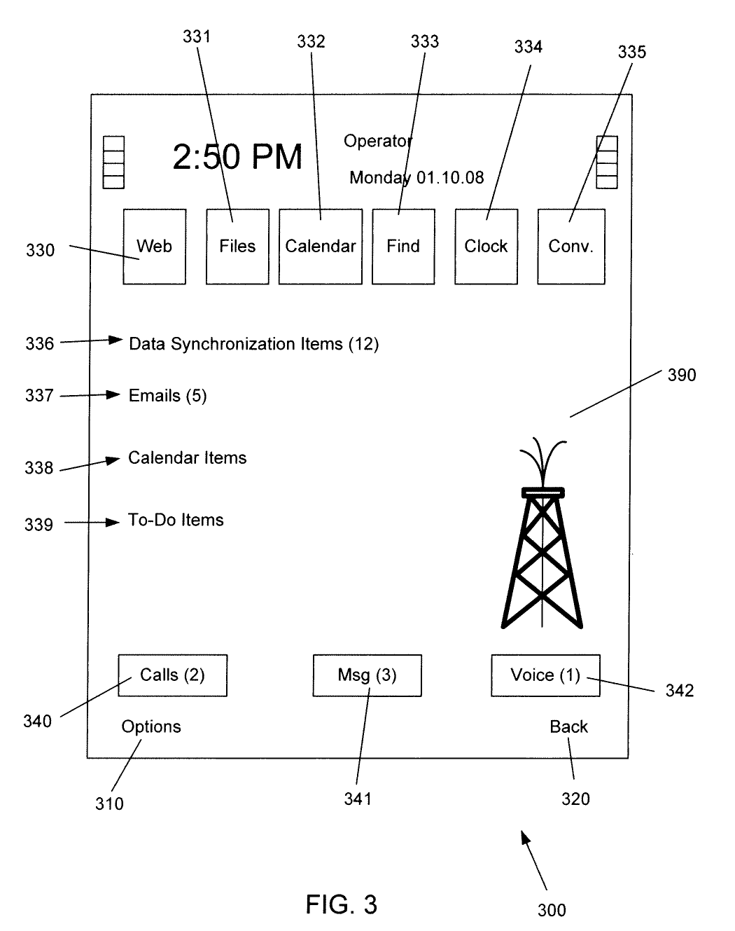

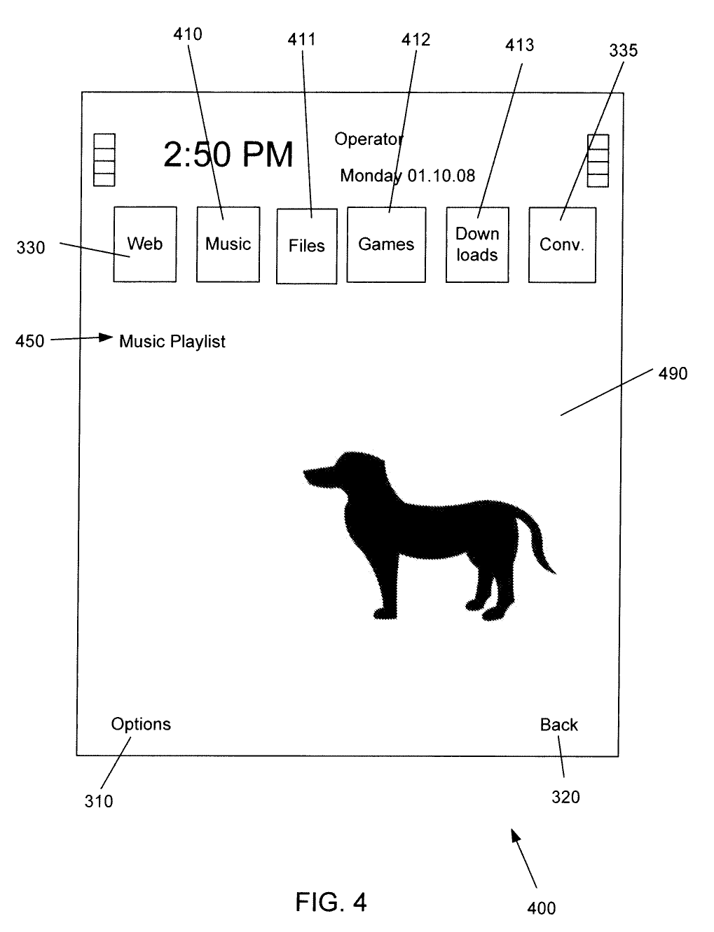

The disclosed embodiments can also allow for the separation of business use and personal use of the device 100 in any suitable manner. Referring now to FIGS. 3 and 4, exemplary screen shots of user interfaces 300, 400 are shown in accordance with the disclosed embodiments. The user interfaces 300, 400 in this example respectively are home screens for a work user profile and a home profile. As can be seen in FIG. 3, the work profile user interface 300 can include any suitable information including, but not limited to, application shortcuts or links to web browsers 330, work files 331, calendars 332, search engines 333, world clocks 334 and conversion applications 335 (e.g. monetary or unit of measure conversions). The user interface 300 can also include, as a non-limiting example, notifications pertaining to data synchronization 336, emails 337, calendar items 338, to-do list items 339, missed calls 340, text messages 341 and voice messages 342. As can be seen in FIG. 3, the number of items within each notification can be displayed for the user's reference. For example, notifier 337 indicates the user has five emails. The user interface 300 may also include any suitable soft key functions 310, 320.

When the user interface mode is switched from the work profile user interface 300 to for example, a home profile user interface 400 shown in FIG. 4, any suitable user interface information will change. As a non-limiting example, when the user interfaces are changed or switched one or more of the background, application shortcuts, soft key shortcuts and visibility of the home screen information plug-ins (such as e.g. calendar event notifiers, email, etc.) may change so that only information related to the active profile is presented on the display. As can be seen in FIG. 4, when the device 100 is switched from the work profile user interface mode 170 to the home profile user interface mode 171 one or more of the application links 330-335 are changed to the application links shown in FIG. 4. For example, the browser 330 and converter 335 applications may remain the same but the other application links 331-334 change to links for music player 410, home file 411, gaming 412, and file download 413 applications. In other words, application menu items and/or application access can be changed, disabled, enabled and/or hidden based on the active interface mode. In this example, the background also changes from background 390 to background 490 and the notifications 336-342 change to a music playlist 450. It is noted that the home screens for the work and home profile user interfaces 300, 400 are shown for exemplary purposes only and that one or more of the user interface features may or may not change when switching user interface modes.

In one embodiment application features and/or settings can also change when profiles 170-172 are changed. For example, an email information plug-in such as email notifier 337 in FIG. 3 may attach to different email accounts in different modes. For example, the email plug-in may attach to a business email account while in the first profile 170 and a personal email account in the second profile 171. The settings for the respective email accounts can also change. For example, when in the first profile 170, a work email account push can be set as always on but when in the second profile 171 the push for the work email account can be turned off so that work email is only delivered to the device 100 upon request by the user or when polled by the device 100. Similarly a calendar plug-in such as, calendar notifier 338 can point to different calendars (e.g. work calendars, non-work calendars, etc.) depending on the selected profile 170-172.

Connectivity settings can also change depending on the active profile 170-172. For example, voice over internet protocol (VOIP) settings can change (e.g. switching from a business VOIP account to another VOIP account) and/or network connection settings can change (e.g. at work the system 100 accesses a work wireless local area network and at home the system 100 accesses a home wireless local area network). As other examples, the clock type can also change from an analog to digital appearance and/or from a world clock showing the time in two or more time zones or cities to a simple clock. A homepage and/or shortcuts of the web browser 330 can also change depending on which user interface mode 170-172 is active. The behavior and function of hard and/or soft keys 110 can change depending on which profile 170-172 is active as well in a manner similar to that described above.

The disclosed embodiments can also screen communications made or received by the device 100. For example, contacts associated with the active profile are allowed to call, email or otherwise contact the user of the device 100 while other contacts are not able to communicate with the user and vice versa. For example, while in a work profile 170, work contacts are allowed to communicate with the user of the device 100 while contacts related to, for example, the home profile 171 can not. In this embodiment it is noted that there may be limited access from contacts outside of the active profile. For example, the user's immediate family may be allowed to contact the user when the device 100 is in the work profile 170 for emergency purposes and vice versa.

In another embodiment, the voice mail box number can change depending on which profile 170-172 is active. For example, the voice mail messages can be changed automatically according to the active mode (e.g. work related voice mail is presented in the work profile 170 and non-work related voice mail is presented in the home profile 171). Call waiting, call barring and call divert (for e.g. voice, video, fax or any other suitable call) can be changed based on the user interface mode. Speed dial numbers can also change depending on the user interface mode. For example, the user can have important business contacts listed in speed dial of the first profile 170 and important non-work related contacts in other profiles 171, 172.

In one embodiment, music playlists can also change based on the user interface mode. For example, in a vacation profile, such as the third profile 172, the playlist(s) can include music corresponding to the geographic location the user is visiting, while the playlists in a gym profile mode can include music that motivates a user to exercise. RSS feeds can change base on the active profile as well. For example, the order of the subscribed feeds can change and the RSS feeds visible on the respective profile displays can change based on the active profile. Further, the graphics and lighting in hard or soft keys 110 can change depending on the profile. For example, the graphics and/or lighting can change patterns or be enabled or disabled depending on the profile. A data input method may also be changed depending on the profile. For example, text prediction can be turned on or off or the language of dictionaries used by text recognition software can be switched based on the active profile.

The profiles 170-172 can also provide security features to protect any suitable information or data related to the different profiles 170-172 from being accessed outside of the respective profile 170-172. As a non-limiting example, when the second or home profile 171 is active, the user can lock the applications and information associated with the first or work profile 170 while at the same time allowing the non-work related applications and information to be accessed by the user's family and/or friends. In another example, network access points can be restricted in any suitable manner. For example the second or home profile 171 can be configured to restrict access to a wireless access point related to the user's work place. In still other embodiments a memory card of the device 100 can be locked. In other embodiments, display views of the device can be locked when the profiles 170-172 are changed. For example, if the device includes a database that is used for both work and business, the first or work profile 170 the display view of the database will be locked to a work display view of the database so that the home display view is inaccessible while in work profile 170.

The profiles can also be configured so they can access information in other profiles through any suitable security processes including, but not limited to one or more of passwords, encryption, smart cards, biometrics, voice recognition or any other suitable security measures. For example, if the device is in a home profile 171 and the user has to access work related information but does not want to or is not able to switch modes (e.g. due to company policy or a setting in the device 100), the user can, for example, enter a personal identification number granting the user access to the work information. The access to information belonging to another profile can be provided in any suitable manner such as on a timed basis, one time access basis (e.g. access to work related data is terminated once the work related data is closed), etc. The above noted security features can also be implemented to enable the switching of the profiles (e.g. the profiles will not change unless a predetermined security criteria is satisfied).

In one embodiment, the different profiles provide companies with a way to control costs with respect to, for example, company issued mobile communication devices. For example, the company can determine (based on time of day, location, etc.) when the profile is switched from a work profile 171 to any suitable leisure time profile such as the second or home profile 171. In one example, the company can utilize one or more of alternative line service in the device 100, enforced access points (e.g. only certain networks can be accessed depending on the active user interface) and forced prefixes on dialed numbers to separate leisure time use and business use and their respective connection fees from each other. In other embodiments any suitable criteria or features can be used by a company to separate leisure time use from business use.

In one example, the company can issue or a user can purchase (or otherwise acquire) a device 100 with subscriber identity modules (SIMs) having alternative line service (i.e. two different phone numbers and operator accounts for business and private use). The active line or service can automatically be switched depending on which profile is active. For example, the business phone number account may be switched to a home phone number account when the profile modes are switched from the first profile 170 to the second profile 171. The profile change can also trigger automatic insertion of a certain predetermined number prior to a dialed number to allow any suitable billing system to distinguish between business calls and personal calls. For example, the predetermined number may be added when in the second profile 171 or any other suitable profile 170-172. In other examples, each profile 170-172 may have its own predetermined prefix that is added to communications for distinguishing costs pertaining to each of the profile 170-172.

In another embodiment the profile change can force a user to a closed user group. For example, this may allow the user to only call or otherwise contact one or more entities from a predetermined list of contacts when a respective mode is active. For example, while at work the work user interface will only allow the user to communicate with work related parties. In combination with non-user editable mode settings and business/personal call separation, the profiles 170-172 allow for additional cost control for companies as the user of the device 100 cannot call or otherwise contact entities outside those listed in the predetermined contact list during the user's work time.

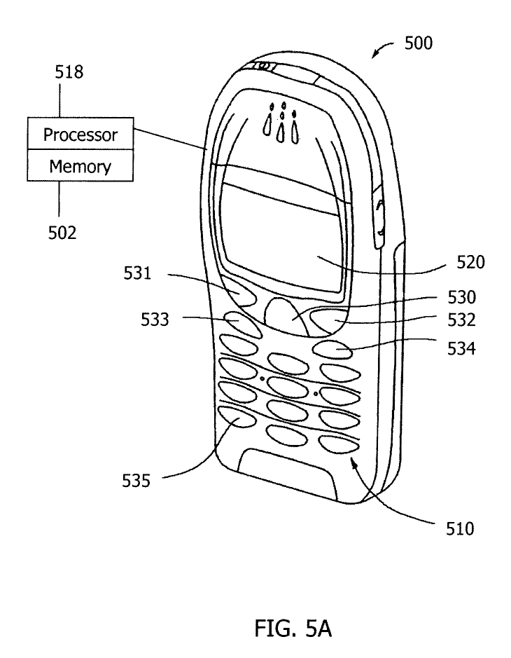

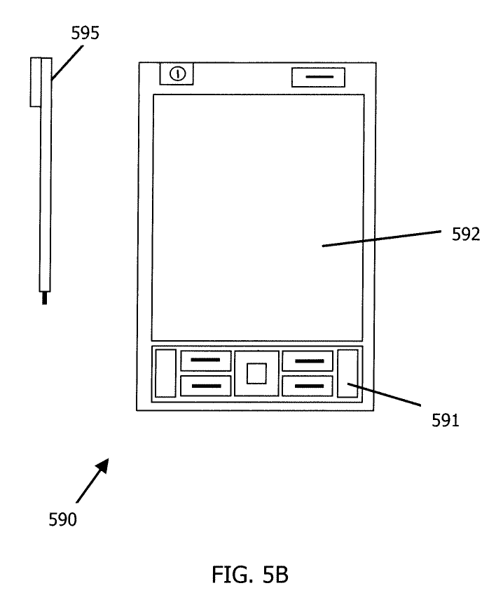

Examples of devices on which aspects of the disclosed embodiments can be practiced are illustrated with respect to FIGS. 5A and 5B. The terminal or mobile communications device 500 may have a keypad 510 and a display 520. The keypad 510 may include any suitable user input devices such as, for example, a multi-function/scroll key 530, soft keys 531, 532, a call key 533, an end call key 534 and alphanumeric keys 535. The display 520 may be any suitable display, such as for example, a touch screen display or graphical user interface. The display may be integral to the device 500 or the display may be a peripheral display connected to the device 500. A pointing device, such as for example, a stylus, pen or simply the user's finger may be used with the display 520. In alternate embodiments any suitable pointing device may be used. In other alternate embodiments, the display may be for example a flat display that is typically made of an liquid crystal display (LCD) with optional back lighting, such as a thin film transistor (TFT) matrix capable of displaying color images. In still other alternate embodiments, the display may be any suitable conventional display. The device 500 may also include other suitable features such as, for example, a camera, loud speaker, connectivity port or tactile feedback features. The mobile communications device may have a processor 518 connected to the display for processing user inputs and displaying information on the display 520. A memory 502 may be connected to the processor 518 for storing any suitable information and/or applications associated with the mobile communications device 500 such as phone book entries, calendar entries, the user interface mode application 181 described herein, etc.

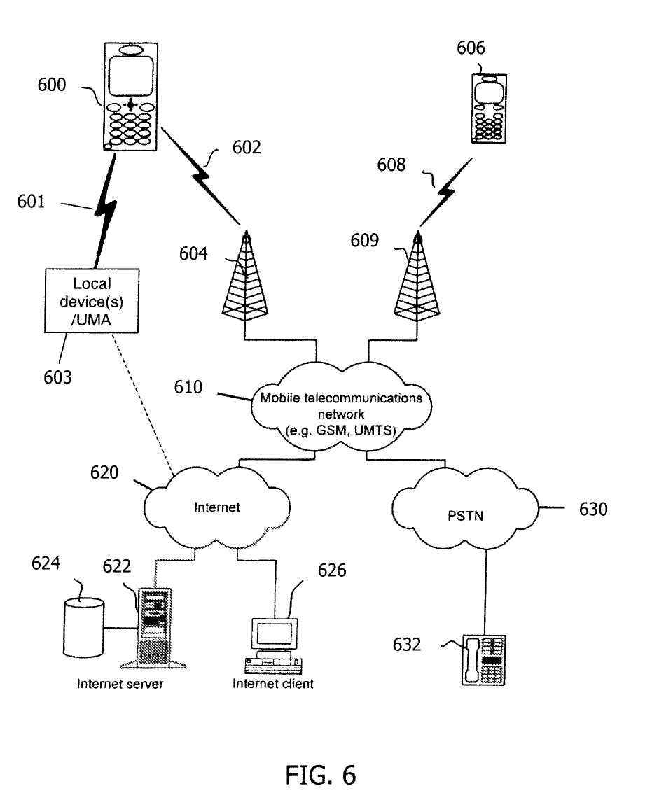

In the embodiment where the device 500 comprises a mobile communications device, the device can be adapted for communication in a telecommunication system, such as that shown in FIG. 6. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 600 and other devices, such as another mobile terminal 606, a line telephone 632, a personal computer 626 and/or an internet server 622. It is to be noted that for different embodiments of the mobile terminal 600 and in different situations, some of the telecommunications services indicated above may or may not be available. The aspects of the disclosed embodiments are not limited to any particular set of services in this respect.

The mobile terminals 600, 606 may be connected to a mobile telecommunications network 610 through radio frequency (RF) links 602, 608 via base stations 604, 609. The mobile telecommunications network 610 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 610 may be operatively connected to a wide area network 620, which may be the Internet or a part thereof. An Internet server 622 has data storage 624 and is connected to the wide area network 620, as is an Internet client computer 626. The server 622 may host a worldwide web/wireless application protocol server capable of serving worldwide web/wireless application protocol content to the mobile terminal 600.

A public switched telephone network (PSTN) 630 may be connected to the mobile telecommunications network 610 in a familiar manner. Various telephone terminals, including the stationary telephone 632, may be connected to the public switched telephone network 630.

The mobile terminal 600 is also capable of communicating locally via a local link 601 to one or more local devices 603. The local link 601 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The above examples are not intended to be limiting, and any suitable type of link may be utilized. The local devices 603 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 600 may thus have multi-radio capability for connecting wirelessly using mobile communications network 610, wireless local area network or both. Communication with the mobile telecommunications network 610 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the processor 122 of FIG. 1 can include a communications module that is configured to interact with the system described with respect to FIG. 6.

Although the above embodiments are described as being implemented on and with a mobile communication device, it will be understood that the disclosed embodiments can be practiced on any suitable device incorporating a display, processor, memory and supporting software or hardware. In one embodiment, the device 100 of FIG. 1 may be for example, a personal digital assistant (PDA) style device 590 illustrated in FIG. 5B. The personal digital assistant 590 may have a keypad 591, a touch screen display 592 and a pointing device 595 for use on the touch screen display 592. In still other alternate embodiments, the device may be a personal computer, a tablet computer, touch pad device, Internet tablet, a laptop or desktop computer, a mobile terminal, a cellular/mobile phone, a multimedia device, a personal communicator, or any other suitable device capable of containing for example a display 114 shown in FIG. 1, and supported electronics such as the processor 122 and memory 182.

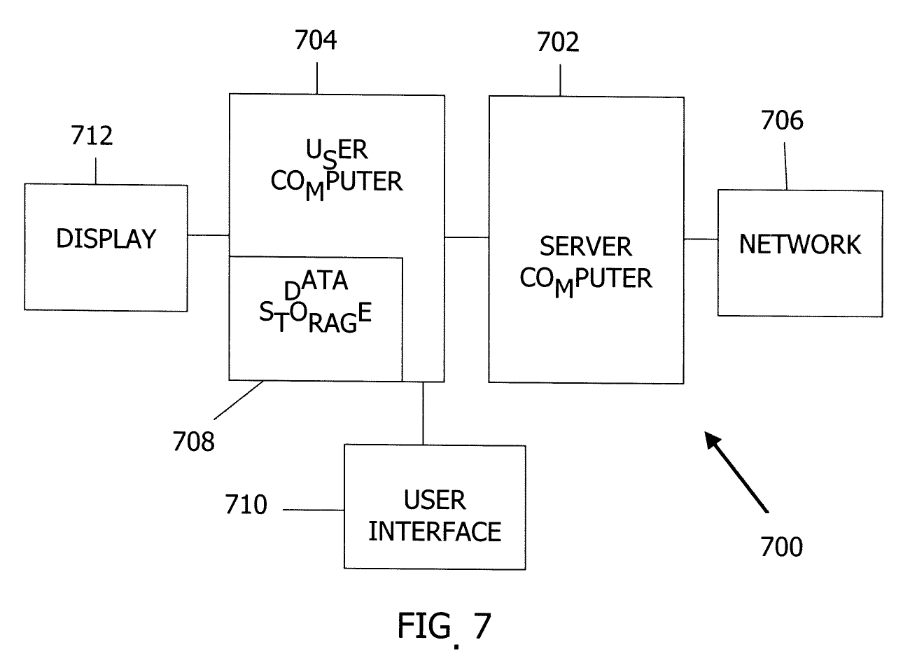

The disclosed embodiments may also include software and computer programs incorporating the process steps and instructions described above that are executed in different computers. FIG. 7 is a block diagram of one embodiment of a typical apparatus 700 incorporating features that may be used to practice aspects of the invention. The apparatus 700 can include computer readable program code means for carrying out and executing the process steps described herein. As shown, a computer system 702 may be linked to another computer system 704, such that the computers 702 and 704 are capable of sending information to each other and receiving information from each other. In one embodiment, computer system 702 could include a server computer adapted to communicate with a network 706. Computer systems 702 and 704 can be linked together in any conventional manner including, for example, a modem, wireless, hard wire connection, or fiber optic link. Generally, information can be made available to both computer systems 702 and 704 using a communication protocol typically sent over a communication channel or through a dial-up connection on an integrated services digital network (ISDN) line. Computers 702 and 704 are generally adapted to utilize program storage devices embodying machine-readable program source code, which is adapted to cause the computers 702 and 704 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 702 and 704 may also include a microprocessor for executing stored programs. Computer 704 may include a data storage device 708 on its program storage device for the storage of information and data. The computer program or software incorporating the processes and method steps incorporating aspects of the invention may be stored in one or more computers 702 and 704 on an otherwise conventional program storage device. In one embodiment, computers 702 and 704 may include a user interface 710, and a display interface 712 from which aspects of the invention can be accessed. The user interface 710 and the display interface 712 can be adapted to allow the input of queries and commands to the system, as well as present the results of the commands and queries.

The embodiments described herein are provided as non-limiting examples of switchable user interface modes that allow a user to balance his or her personal life with work and other activities. The disclosed embodiments provide, for example, a single mobile communication device with two or more personalities that match the different activities or life roles. In accordance with the disclosed embodiments, the user does not have to use more than one device for each of the user's roles or use a device that is not suited for the user's various roles (i.e. the device compromises, for example, performance, efficiency and/or enjoyment of use for each of the user's roles/activities).

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
storing one or more user profile modes in a device;
activating a user profile from the stored profiles where activating a user profile mode comprises:
configuring a user interface of the device to allow access to only applications and/or information associated with the activated user profile mode; and
displaying only applications and/or information associated with the activated user profile mode.

2. The method of claim 1, further comprising storing mode settings for the one or more user profile modes in a private storage.

3. The method of claim 2, wherein the mode settings include links or pointers to applications and information associated with the activated user profile mode.

4. The method of claim 1, wherein at least some information and/or applications associated with inactive user profile modes are not accessible, are hidden or are accessible through security features of the device.

5. The method of claim 1, wherein one or more user profile modes are configured to provide cost control based on a type of use of the device.

6. The method of claim 1, wherein a functionality of one or more device and/or application features are modified depending on the active user profile mode.

7. A computer program product embodied in a memory of a device comprising:
computer readable program code embodied in a computer readable medium for executing the method of claim 1.

8. The computer program product of claim 7, wherein mode settings for the one or more user profile modes are stored in a private storage.

9. The computer program product of claim 7, wherein a functionality of one or more device and/or application features are modified depending on the active user profile mode.

10. The computer program product of claim 7, further comprising computer readable program code embodied in a computer readable medium for precluding access to, providing selective access to, or hiding at least some information and/or applications depending on the active user profile mode.

11. An apparatus comprising:
a processor;
a display connected to the processor; and
a memory connected to the processor;
wherein the processor is configured to:
store one or more user profile modes in the memory;
activate a user profile from the stored profiles where when activating the user profile mode the processor is further configured to:
configure a user interface of the apparatus to allow access to only applications and/or information associated with the activated user profile mode; and
display only applications and/or information associated with the activated user profile mode.

12. The apparatus of claim 11, wherein the processor is further configured to store mode settings for the one or more user profile modes in a private storage.

13. The apparatus of claim 12, wherein the mode settings include links or pointers to applications and information associated with the activated user profile mode.

14. The apparatus of claim 11, wherein the processor is further configured to modify a functionality of one or more device and/or application features depending on the activated user profile mode.

15. The apparatus of claim 11, wherein at least some information and/or applications associated with inactive user profile modes are not accessible, are hidden or are accessible through security features of the apparatus.

16. The apparatus of claim 11, wherein the apparatus comprises a mobile communication device.

17. A system comprising:
a communication device including a display, a memory and a processor connected to the display and memory, the processor being configured to:
store one or more user profile modes in the memory;
activate a user profile from the stored profiles where when activating the user profile mode the processor is further configured to:
configure a user interface of the device to allow access to only applications and/or information associated with the activated user profile mode; and
display only applications and/or information associated with the activated user profile mode.

18. The system of claim 17, wherein the processor is further configured to store mode settings for the one or more user profile modes in a private storage.

19. The system of claim 18, wherein the mode settings include links or pointers to applications and information associated with the activated user profile mode.

20. The system of claim 17, wherein the processor is further configured to modify a functionality of one or more device and/or application features depending on the activated user profile mode.

21. A user interface comprising:
an input device;
a display; and
a processor connected to the input and display, the processor being configured to:
store one or more user profile modes in the memory;
activate a user profile from the stored profiles where when activating the user profile mode the processor is further configured to:
configure a user interface of the device to allow access to only applications and/or information associated with the activated user profile mode; and
display only applications and/or information associated with the activated user profile mode.

22. The user interface of claim 21, wherein the processor is further configured to store mode settings for the one or more user profile modes in a private storage.

23. The user interface of claim 21, wherein the mode settings include links or pointers to applications and information associated with the activated user profile mode.

24. The user interface of claim 21, wherein the processor is further configured to modify a functionality of one or more device and/or application features depending on an active one of the plurality of user interfaces.

25. An apparatus comprising:
means for storing one or more user profile modes in a device; and
means for activating a user profile from the stored profiles where activating a user profile mode comprises:
configuring a user interface of the device to allow access to only applications and/or information associated with the activated user profile mode; and
displaying only applications and/or information associated with the activated user profile mode.

26. The apparatus of claim 25, wherein at least some information and/or applications associated with inactive user profile modes are not accessible, are hidden or are accessible through security features of the device.

27. The apparatus of claim 25, wherein a functionality of one or more device and/or application features are modified depending on the active user profile mode.
